(19) United States
(12) Patent Application Publication
(10) Pub. No.: US 2024/0320452 A1
(43) Pub. Date: Sep. 26, 2024

(54) METHODS AND SYSTEMS FOR REDUCING JAMMING BETWEEN TAG READERS

(71) Applicant: Sensormatic Electronics, LLC, Boca Raton, FL (US)

(72) Inventors: Steven E. TRIVELPIECE, Rancho Santa Margarita, CA (US); Adam S. BERGMAN, Boca Raton, FL (US); John J. CLARK, Boynton Beach, FL (US); John A. ALLEN, Pompano Beach, FL (US)

(21) Appl. No.: 18/579,763

(22) PCT Filed: Jul. 19, 2022
(86) PCT No.: PCT/US2022/073889

§ 371 Date: Jan. 16, 2024

Related U.S. Application Data
(60) Provisional application No. 63/223,717, filed on Jul. 20, 2021.

(51) Int. Cl. G06K 7/10; G06K 7/00

(52) U.S. Cl. CPC G06K 7/10069; G06K 7/0008

(57) ABSTRACT

Examples described herein generally relate to a system for monitoring tags in a retail environment. The system includes an exit system including one or more radio frequency identification (RFID) readers that read a tag to obtain exit system measurements associated with a tag detection event. The system includes a memory and a processor configured to execute instructions to configuring each of a plurality of exit gates including a plurality of RFID readers with a different operating frequency than the plurality of RFID readers at an adjacent exit gate. The processor is configured to synchronize the plurality of RFID readers at each exit gate to prevent two readers at the exit gate from concurrently talking with overlapping coverage areas and a same polarization. The processor is configured to detect one or more tags within the coverage areas.

### CROSS REFERENCE TO RELATED APPLICATIONS

This application claims priority to U.S. Provisional Application No. 63/223,717 titled “METHODS AND SYSTEMS FOR REDUCING JAMMING BETWEEN TAG READERS,” filed Jul. 20, 2021, which is assigned to the assignee hereof, and incorporated herein by reference in its entirety.

### BACKGROUND

The present disclosure relates to monitoring retail locations, and more particularly to determining a status of a tag in a retail environment.

Retailers detect movement of goods using a security tag attached to the goods and sensors that detect the location of the security tag. A security system may include an exit system (e.g., a pedestal including a reader) that detects the presence of a tag. A retail location may include multiple exit systems, each of which may include multiple readers. In some scenarios, signals transmitted by one reader may interfere with signals transmitted by tags and/or jam other readers. Such interference and jamming may reduce the number of detections of tags in the vicinity of the exit systems.

Thus, there is a need in the art for improvements in determining a status of security tags. In particular, there is a need for systems and methods for reducing jamming between tag readers.

### SUMMARY

The following presents a simplified summary of one or more implementations of the present disclosure in order to provide a basic understanding of such implementations. This summary is not an extensive overview of all contemplated implementations, and is intended to neither identify key or critical elements of all implementations nor delineate the scope of any or all implementations. Its sole purpose is to present some concepts of one or more implementations of the present disclosure in a simplified form as a prelude to the more detailed description that is presented later.

In some aspects, the techniques described herein relate to a radio frequency identification (RFID) reader including: an antenna component configurable to transmit on an operating frequency using one of two polarizations; and a controller configured to: select the operating frequency that is the same as an operating frequency of one or more RFID readers located at a same exit gate and different from an operating frequency of an RFID reader located at an adjacent exit gate; synchronize with the one or more RFID readers located at the same exit gate to talk at a different time, with a different coverage area, or with a different polarization than the one or more RFID readers located at the same exit gate; and detect one or more tags within a selected coverage area.

In some aspects, the techniques described herein relate to a RFID reader, wherein to synchronize with the one or more RFID readers located at the same exit gate, the controller is configured to receive a schedule for talking that does not overlap with any schedule of the one or more RFID readers located at the same exit gate.

In some aspects, the techniques described herein relate to a method, wherein to synchronize with the one or more RFID readers located at the same exit gate, the controller is configured to talk concurrently with another RFID readers located at the same exit gate with an opposite polarization.

In some aspects, the techniques described herein relate to a RFID reader where the antenna component is configurable to transmit using one of at least three beams, wherein to synchronize with the one or more RFID readers located at the same exit gate, the controller is configured to talk concurrently with another RFID readers located at the same exit gate with non-overlapping beams.

In some aspects, the techniques described herein relate to a RFID reader, wherein the different operating frequency is selected from a set of three available operating frequencies.

In some aspects, the techniques described herein relate to a RFID reader, wherein the adjacent exit gate is configured with a second available operating frequency and a second adjacent exit gate on an opposite side of the exit gate is configured with a third available operating frequency.

In some aspects, the techniques described herein relate to a RFID reader, wherein the RFID reader is separated from another exit gate operating on the same frequency by at least two exit gates operating on different operating frequencies.

In some aspects, the techniques described herein relate to a RFID reader, wherein the plurality of exit gates are arranged linearly and the operating frequency for each exit gate along a line cycles through the three available operating frequencies.

In some aspects, the techniques described herein relate to a RFID reader, wherein to synchronize with the one or more RFID readers located at the same exit gate, the controller is configured to select a transmit power for each RFID reader based on a direction of a beam.

In some aspects, the techniques described herein relate to a RFID reader, wherein to synchronize with the one or more RFID readers located at the same exit gate, the controller is configured to utilize a greater amount of dual target reading sessions than single target reading sessions.

In some aspects, the techniques described herein relate to a system including: a plurality of radio frequency identification (RFID) readers located at each of a plurality of exit gates, each exit gate configured with a different operating frequency than an adjacent exit gate; and a controller configured to: synchronize the plurality of RFID readers at one of the exit gates to prevent two readers at the exit gate from concurrently talking with overlapping coverage areas and a same polarization; and detect one or more tags within the coverage areas.

In some aspects, the techniques described herein relate to a system, wherein to synchronize the plurality of RFID readers at the exit gate, the controller is configured to configure the plurality of RFID readers with non-overlapping schedules for talking.

In some aspects, the techniques described herein relate to a system, wherein to synchronize the plurality of RFID readers at the exit gate, the controller is configured to configure two of the plurality of RFID readers to talk concurrently with opposite polarizations.

In some aspects, the techniques described herein relate to a system, wherein to synchronize the plurality of RFID readers at the exit gate, the controller is configured to configure two of the plurality of RFID readers to talk concurrently with non-overlapping beams.

In some aspects, the techniques described herein relate to a system, wherein the different operating frequency is selected from a set of three available operating frequencies.

In some aspects, the techniques described herein relate to a system, wherein the adjacent exit gate is configured with a second available operating frequency and a second adjacent exit gate on an opposite side of the exit gate is configured with a third available operating frequency.

In some aspects, the techniques described herein relate to a system, wherein a closest exit gate operating on a same operating frequency as any of the plurality of exit gates is separated by at least two exit gates operating on different operating frequencies.

In some aspects, the techniques described herein relate to a system, wherein the plurality of exit gates are arranged linearly and the operating frequency for each exit gate along a line cycles through the three available operating frequencies.

In some aspects, the techniques described herein relate to a system, wherein to synchronize the plurality of RFID readers at the exit gate, the controller is configured to select a transmit power for each RFID reader based on a direction of a beam.

In some aspects, the techniques described herein relate to a system, wherein to synchronize the plurality of RFID readers at the exit gate, the controller is configured to configure the plurality of RFID readers to utilize a greater amount of dual target reading sessions than single target reading sessions.

In some aspects, the techniques described herein relate to a method including: configuring each of a plurality of exit gates including a plurality of radio frequency identification (RFID) readers with a different operating frequency than the plurality of RFID readers at an adjacent exit gate; synchronizing the plurality of RFID readers at each exit gate to prevent two readers at the exit gate from concurrently talking with overlapping coverage areas and a same polarization; and detecting one or more tags within the coverage areas.

In some aspects, the techniques described herein relate to a method, wherein synchronizing the plurality of RFID readers at an exit gate includes configuring the plurality of RFID readers with non-overlapping schedules for talking.

In some aspects, the techniques described herein relate to a method, wherein synchronizing the plurality of RFID readers at an exit gate includes configuring two of the plurality of RFID readers to talk concurrently with opposite polarizations.

In some aspects, the techniques described herein relate to a method, wherein synchronizing the plurality of RFID readers at an exit gate includes configuring two of the plurality of RFID readers to talk concurrently with non-overlapping beams.

In some aspects, the techniques described herein relate to a method, wherein the different operating frequency is selected from a set of three available operating frequencies.

In some aspects, the techniques described herein relate to a method, wherein the adjacent exit gate is configured with a second available operating frequency and a second adjacent exit gate on an opposite side of the exit gate is configured with a third available operating frequency.

In some aspects, the techniques described herein relate to a method, wherein a closest exit gate operating on a same operating frequency as any of the plurality of exit gates is separated by at least two exit gates operating on different operating frequencies.

In some aspects, the techniques described herein relate to a method, wherein the plurality of exit gates are arranged linearly and the operating frequency for each exit gate along a line cycles through the three available operating frequencies.

In some aspects, the techniques described herein relate to a method, wherein synchronizing the plurality of RFID readers at each exit gate includes selecting a transmit power for each RFID reader based on a direction of a beam.

In some aspects, the techniques described herein relate to a method, wherein synchronizing the plurality of RFID readers at each exit gate includes utilizing a greater amount of dual target reading sessions than single target reading sessions.

Additional advantages and novel features relating to implementations of the present disclosure will be set forth in part in the description that follows, and in part will become more apparent to those skilled in the art upon examination of the following or upon learning by practice thereof.

### DESCRIPTION OF THE FIGURES

In the drawings:

FIG. 1 is a schematic diagram of an example retail location including a first example of a security system.

FIG. 2 is a schematic diagram of an example retail location including a second example of a security system.

FIG. 3 is a diagram of a security system including radio frequency identification (RFID) readers configured to transmit different beams according to an example configuration, in accordance with an implementation of the present disclosure.

FIG. 4 is a diagram of an example computer system implementing a security system including an RFID reader configuration application, in accordance with an implementation of the present disclosure.

FIG. 5 is a flowchart of an example method of configuring RFID readers, in accordance with an implementation of the present disclosure.

FIG. 6 is a schematic block diagram of an example computer device, in accordance with an implementation of the present disclosure.

### DETAILED DESCRIPTION

The present disclosure provides systems and methods for detecting tags in a retail environment. The disclosure provides for configuration of a multiple exit gates and readers to provide coverage of an area of interest and allowing a high rate of tag detections.

Radio frequency identification (RFID) tags may be read by an RFID reader. RFID reader hardware allows for configuration of various parameters including an operating frequency, direction or beam, and polarization. In some scenarios, multiple RFID readers can be located in an area of interest (e.g., a retail location exit) to scan tags. The multiple RFID readers may each be configured with a different operating frequency to limit interference between the RFID readers. For example, the co-channel rejection between the different frequencies may result in a received signal strength indicator (RSSI) variation of plus or minus 0.5 dB to 2 dB when multiple readers at a pedestal are talking concurrently. As used herein, “talk” refers to the action of an RFID reader transmitting a signal and receiving a response from an RFID tag. The multiple RFID readers may provide multiple detections of a tag moving through the area of interest. The multiple detections may be analyzed to determine movement of the tag and likelihood of security issues.

In some scenarios, the number of operating frequencies may be limited to be less than a desired number of RFID readers. For instance, allocation of radio frequencies may be subject to national or regional regulations. In some cases, high power bands useful for RFID readers may be limited to three available operating frequencies. In such a scenario, if RFID readers located at the same pedestal are configured with different operating frequencies, the selected operating frequencies may be the same operating frequencies as an adjacent pedestal or exit gate. Amplitude modulated RFID tags may jammed by interfering signals from different pedestals. Additionally, the receivers of the RFID readers may be jammed by signals transmitted by the adjacent pedestal or exit gate. Such jamming may reduce total tag detections by up to 90%, which reduces the ability to analyze detections and detect security events.

In an example, the present disclosure provides a tag detection system and methods for configuring the tag detection system to utilize a same operating frequency for all RFID readers at an exit gate and different operating frequency for adjacent exit gates. Further, the RFID readers at an exit gate may be configured to use a different coverage area and/or polarization when talking at the same time to further increase co-channel rejection and/or improve tag detection. For example, the coverage area may be controlled using beam steering antennas to select beams that are not overlapping. The antennas may be dual linear antennas that allow selection of opposite polarizations for concurrent transmissions.

Further, the coverage area of the RFID reader may be controlled based on a transmission power. For instance, transmission power may be increased for coverage areas where there are likely to be fewer tags (e.g., beams pointing outside of the retail location).

Additionally, session logic may be used to increase reading rates. Reading sessions may detect single targets or dual targets. By having a lower amount of time dedicated to single target sessions, new tags moving into the area of interest can be read at least once. For example, one third of the time may be assigned to single target sessions and two-thirds of the time may be assigned to dual target sessions. Such a session configuration may provide fast reading of new tags and multiple reads on tags that are close, while still reading distant static tags on an acceptable periodic basis.

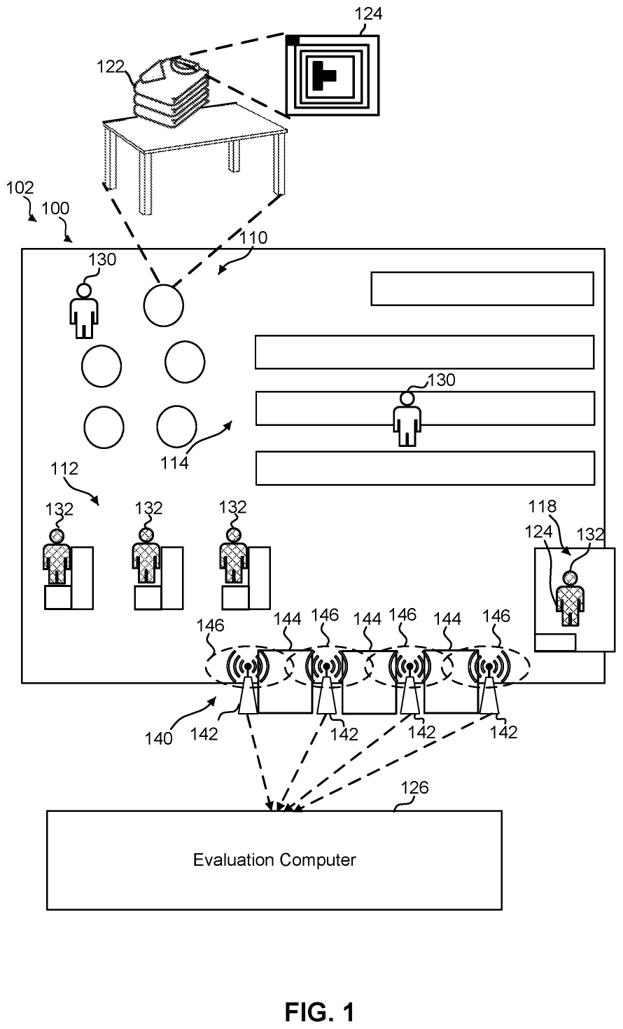

Referring now to FIG. 1, an example retail location 100 includes multiple regions where tagged products may be located. For example, the retail location 100 may include an open display area 110, a front end 112, aisles 114, and a security room 118. Customers 130 may be located within the different regions. Workers 132 may be stationed at locations such as check out registers and the security room 118. A person of skill in the art would understand that the disclosed systems and methods are applicable to a variety of retail locations and the present disclosure is not limited to the example retail location or areas.

As discussed above, retailers (e.g., apparel retailers) have deployed security tags such as radio frequency identification (RFID) systems in stores to track product movements as they arrive at stores, are placed on display on the sales floor, and are sold. By adopting RFID, retailers are able to reduce the amount of time that the store employees spend counting the inventory (e.g., manually counting inventor that is on the floor and in stock room), as well as increase merchandise visibility within each store, thereby enabling shoppers in the store and online to find what they seek. RFID uses radio waves to read and capture information stored on a tag attached to an object such as a good, product, or merchandise. Additionally, RFID tags may be used with a security system to detect inventory changes and possible loss events. For example, RFID tags may be read by an exit system to determine whether a tagged item 122 is leaving the retail location. A tag (e.g., tag 124) can be read from up to several feet away and does not need to be within direct line-of-sight of the reader to be tracked. Although the present disclosure refers to RFID tags, the techniques disclosed herein may be applicable to other types of security tags (e.g., electronic article surveillance (EAS) tags).

An RFID system may be made up of two parts: a tag or label (e.g., EPC tag 124) and a reader (e.g., exit system 140). RFID tags (which may also be referred to as labels) are embedded with an RFID transmitter and a receiver. The RFID component on the tags may include a microchip that stores and processes information, and an antenna to receive and transmit signals. The EPC tag may further contain the specific serial number for each specific object (e.g., an electronic product code (EPC)). For example, in one implementation, an EPC tag may include multiple memory banks such as a reserved memory, EPC memory, tag identification (TID) memory, and user memory. The reserved memory bank may include an access password and a kill password. The EPC memory may include the EPC, a protocol control, and a cyclic redundancy check value. The TID memory may include a tag identification. The user memory may store custom data.

To read the information encoded on an EPC tag 124, a two-way radio transmitter-receiver called an interrogator or reader (e.g., exit system 140) emits a signal to the EPC tag using the antenna (e.g., internal antennas). The exit system 140 may apply filtering to indicate what memory bank the EPC tag 124 should use to respond to the emitted signal. The EPC tag 124 may respond with the information (e.g., EPC value or serial number) written in the memory bank. The EPC tag data set may include any information stored on the EPC tag 124 as well as information about reading the EPC tag 124. For example, the EPC tag data set may include: a timestamp, a location, a signal transmission power, a received signal strength indication (RSSI), and an identifier of the RFID reader (e.g., exit system 140). For purposes of this disclosure, the terms, the EPC tag and RFID tag may be used interchangeably. The EPC tag 124 may be a passive tag or a battery powered EPC tag. A passive RFID tag may use the radio wave energy of the RFID interrogator or receiver 140 to relay the stored information back to the interrogator. In contrast, a battery powered EPC tag 124 may be embedded with a small battery that powers the relay of information.

The security system 102 may include an exit system 140 and an evaluation computer 126. The exit system 140 may include multiple sensors 142 located near exits 144. For example, the example retail location 100 may include three exits 144 that are relatively narrow. The sensors 142 may be located on each side of the exits 144. For example, in an implementation, the sensors 142 may include at least one RFID reader including an antenna that generates a tag detection field 146. Generally, the sensors 142 may be configured (e.g., by setting a power level) such that the tag detection fields 146 cover the exits 144 to detect tags moving through the exits. Although the sensors 142 are illustrated as pedestals adjacent the exits 144, sensors 142 may be located on the floor and/or the ceiling. The sensors 142 may include additional sensors that may produce measurements other than RF measurements. For example, the sensors 142 may include infrared (IR) sensors, inertial sensors, magnetic sensors, or cameras. An exclusion area may be defined near the exit system 140. Tagged products may generally be excluded from the exclusion area to prevent reading by the exit system 140.

The evaluation computer 126 may be a computer device programmed to evaluate at least exit system measurements from the sensors 142. The evaluation computer 126 may be, for example, any mobile or fixed computer device including but not limited to a computer server, desktop or laptop or tablet computer, a cellular telephone, a personal digital assistant (PDA), a handheld device, any other computer device having wired and/or wireless connection capability with one or more other devices, or any other type of computerized device capable of processing exist system measurements.

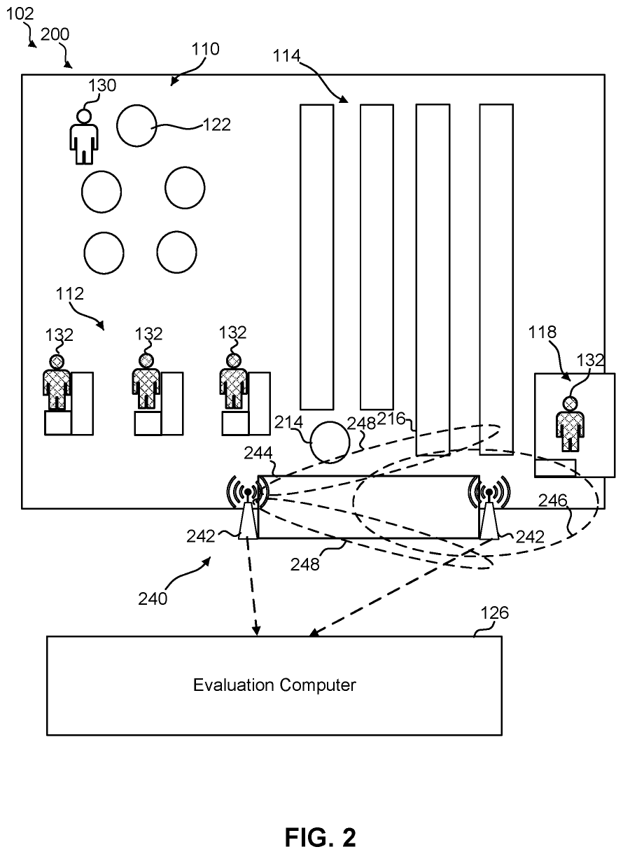

Turning to FIG. 2, a second example retail location 200 may include similar features to the first example retail location 100, but arranged in a different layout. For instance, the second example retail location 200 may be the same physical location as the first example retail location 100 with features rearranged, or a separate physical location. The second example retail location 200 may have a single, relatively large exit 244 compared to the first example retail location 100. In order to cover the exit 244, the sensors 242 of the exit system 240 may, for example, have greater power than the sensors 142 to generate a tag detection field 246. As another example, the sensors 242 may generate beams 248 that are directional tag detection fields. The exit system 140 may be configured by an operator with desired tag detection fields. In another aspect, the exit system 140 may automatically configure itself, for example, by having each sensor detect a distance to the other sensors and controlling a transmit power to generate a tag detection field that covers an area between sensors.

The second example retail location 200 may have a smaller exclusion area around the exit 244 and/or have larger tag detection fields 246, compared to the first example retail location. For example, the retail operator may want to place tagged products on display within the tag detection field 246. In an aspect, detected tags within the tag detection field 246 or beams 248 may indicate a different scenario than detected tags within the tag detection fields 146. For example, tagged merchandise may be placed on a display 214 or a shelf 216 that is near the exit 244. The tag detection field 246 and/or the beam 248 may read such tags even when the merchandise is stationary on the display 214 or shelf 216. Additionally, the tag detection field may cover an area that is outside of the retail location. For instance, a beam may point into a common area of a shopping mall outside of the retail location. The tag detection field may also extend into a portion of an adjacent retail location and detect tags of the adjacent retail location.

In an aspect, for the security system 102 may classify tag detection events to determine a status of the tag. For example, the security system 102 may classify a tag detection event for a tag on the display 214 as a stationary or in location status. The security system 102 may also classify a tag detection event as an out of location tag status for tags that are outside of the retail location. As another example, a tag that is moving within the store but does not pass through an exit may be classified as a parallel status. Generally, such a statuses may not indicate an inventory change event (e.g., the merchandise is not leaving or entering the retail location). Similarly, such a status may not indicate a theft, and the security system 102 may not generate a loss prevention output (e.g., alarm or message) based on the tag detection event. Accordingly, the security system 102 may avoid false alarms.

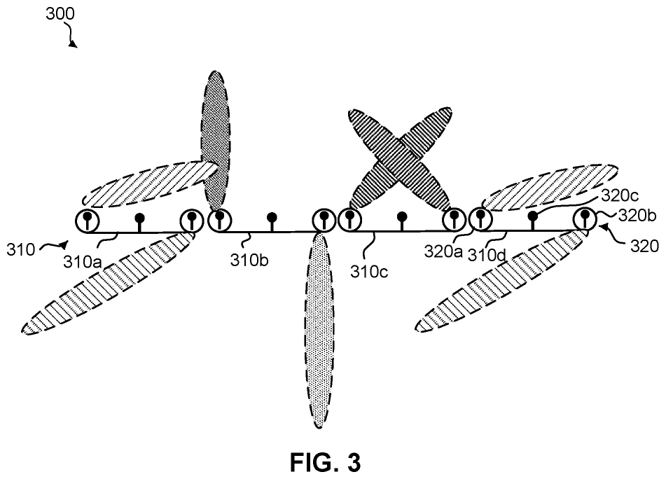

FIG. 3 illustrates an example configuration of an exit system 300, which may be located at a retail location and correspond to an example of the exit system 140 or the exit system 240. The exit system 300 may include multiple exit gates 310 (e.g., 310a, 310b, 310c, 310d). Each exit gate 310 may include multiple RFID readers 320 (e.g., 320a, 320b, 320c). For example, the RFID reader 320a may be located in a first side wall of the exit gate 310, the RFID reader 320b may be located in a second side wall of the exit gate 310, and the RFID reader 320c may be located in a cross-piece of the exit gate 310. In some implementations, the exit gate may be a single pedestal including multiple RFID readers 320, which may be oriented in different directions. In an aspect, each of the RFID readers 320 within an exit gate 310 may be communicatively coupled (e.g., via Ethernet or serial connection) to the other RFID readers 320 in the same exit gate. Additionally, the exit gates 310 may be communicatively coupled via direct connections or a network with a central controller (e.g., evaluation computer 126, not shown).

In an aspect, each exit gate 310 may be configured to operate at an operating frequency that is different than an adjacent exit gate. For example, the exit gate 310a may be configured to operate at an operating frequency A, the exit gate 310b may be configured to operate at an operating frequency B, the exit gate 310c may be configured to operate at an operating frequency C, and the exit gate 310d may be configured to operate at an operating frequency A. Although the exit gate 310a and exit gate 310d may be configured with the same operating frequency, they may be separated by at least two other exit gates. In some implementations, where the exit gates 310 are arranged linearly, the operating frequency of each exit gate 310 may cycle through the available operating frequencies (e.g., A, B, and C). The different operating frequencies may provide channel separation that allows an RFID reader 320 at exit gate 310a to concurrently talk with an RFID reader 320 at exit gate 310b without jamming even if the RFID readers have overlapping coverage areas.

Because each of the RFID readers 320 at an exit gate may use the same operating frequency, there is a risk of interference among the RFID readers. The RFID readers 320 at each exit gate 310 may be synchronized to reduce interference. In an aspect, the plurality of RFID readers 320 at each exit gate 310 may be synchronized to prevent two readers at the exit gate from concurrently talking with overlapping coverage areas and a same polarization. In some implementations, the plurality of RFID readers may be configured with non-overlapping schedules for talking. Non-overlapping schedules may limit a duty cycle of each RFID reader. In some implementations, the duty cycle may be increased by allowing two RFID readers 320 to talk with different coverage areas and/or polarizations. For instance, the RFID readers 320 at exit gate 310a may point in different directions (i.e., into and out of the retail location). As another example, the RFID readers 320 at the exit gate 310c may be configured with different polarizations. As yet another example, the RFID readers 320 at the exit gate 310b may be configured with opposite directions and polarizations.

In some implementations, the coverage area of each RFID reader 320 may be varied (e.g., using a beam sweeping pattern) as long as coverage areas do not overlap. For instance, the beams may be defined by an angle that the beam steers off the lobe from a main axis. In an example where the antennas of the RFID readers 320 allow 13 beams, non-overlapping beams may be separated by more than 14 degrees of separation between the centers of the beams. In some implementations, the transmit power of the RFID readers 320 may be adjusted to reduce jamming or interference, or to increase coverage area. For example, beams pointed outside of a retail location where few tags are expected may be transmitted with greater power than beams pointed into the retail location (e.g., toward a display rack).

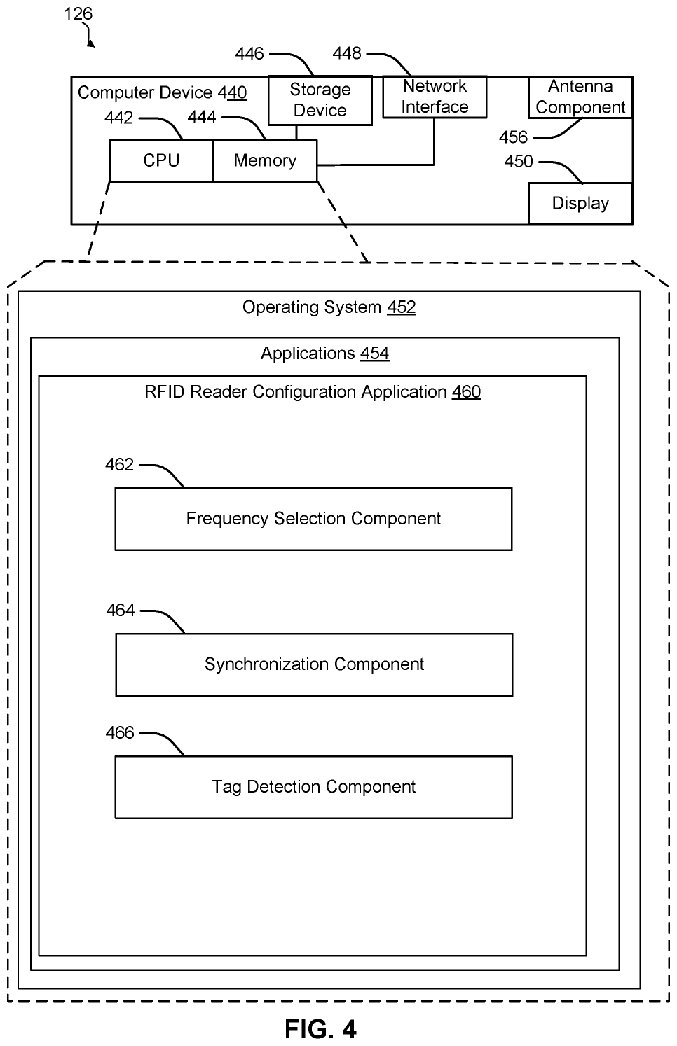

Turning to FIG. 4, an example RFID reader 320 may be a computer device 440 configured to execute a RFID reader configuration application 460. The RFID reader 320 may include an antenna component 456 that is configurable to transmit on an operating frequency using one of at least two polarizations and one of at least three beams. For example, the antenna component 456 may include a plurality of linearly polarized antennas. The antennas may be arranged such that the polarizations are orthogonal to each other. The antenna component 456 may perform beamforming by applying different weights to the antennas. For example, the antenna component 456 may to select between at least three beams to provide different coverage areas. The antenna component 456 may generate the selected beam using beamforming. In some implementations, the antenna component 456 may be capable of generating four or more different beams. In some other examples, the computer device 440 may be an external device such as the evaluation computer 126 that may configure one or more RFID readers 320, for example, by transmitting commands via a network interface 448 to an RFID reader 320.

Whether the computer device 440 is located at an RFID reader 320 or external device, the computer device 440 may include a central processing unit (CPU) 442 that executes instructions stored in memory 444. For example, the CPU 442 may execute an operating system 452 and one or more applications 454, which may include the RFID reader configuration application 460. The computer device 440 may include a storage device 446 for storing data (e.g., exit system measurements and video data streams). The computer device 440 may also include a network interface 448 for communication with external devices via a network. For example, the computer device 440 may communicate with the RFID readers 320.

The computer device 440 may optionally include a display 450. The display 450 may be, for example, a computer monitor and/or a touch-screen. The display 450 may provide information to an operator and allow the operator to configure the computer device 440. In implementations where the computer device 440 is an RFID reader 320, the display 450 may not be present, may be temporarily connected during a configuration process, or may be an external device connected via a network.

Memory 444 may be configured for storing data and/or computer-executable instructions defining and/or associated with an operating system 452 and/or application 454, and CPU 442 may execute operating system 452 and/or application 454. Memory 444 may represent one or more hardware memory devices accessible to computer device 440. An example of memory 444 can include, but is not limited to, a type of memory usable by a computer, such as random access memory (RAM), read only memory (ROM), tapes, magnetic discs, optical discs, volatile memory, non-volatile memory, and any combination thereof. Memory 444 may store local versions of applications being executed by CPU 442. In an implementation, the memory 444 may include a storage device, which may be a non-volatile memory.

The CPU 442 may include one or more processors for executing instructions. An example of CPU 442 can include, but is not limited to, any processor specially programmed as described herein, including a controller, microcontroller, application specific integrated circuit (ASIC), field programmable gate array (FPGA), system on chip (SoC), or other programmable logic or state machine. The CPU 442 may include other processing components such as an arithmetic logic unit (ALU), registers, and a control unit. The CPU 442 may include multiple cores and may be able to process different sets of instructions and/or data concurrently using the multiple cores to execute multiple threads.

The operating system 452 may include instructions (such as applications 454) stored in memory 444 and executable by the CPU 442. The applications 454 may include a RFID reader configuration application 460 configured to configure one or more readers among a plurality of exit gates to reduce interference and jamming between readers. In an aspect, the RFID reader configuration application 460 may select the operating frequency that is the same as an operating frequency of one or more RFID readers located at a same exit gate and different from an operating frequency of an RFID reader located at an adjacent exit gate. For example, due to regulations, there may be a limited number of available operating frequencies (e.g., 3) that is less than a number of RFID readers in a detection system. Additionally, the RFID reader configuration application 460 may synchronize an RFID reader with the one or more RFID readers located at the same exit gate to talk at a different time, with a different coverage area, or with a different polarization than the one or more RFID readers located at the same exit gate. Further, the RFID reader configuration application 460 may detect one or more tags within a selected coverage area.

The RFID reader configuration application 460 may include a frequency selection component 462 that selects the operating frequency. For example, as illustrated in FIG. 3, the frequency selection component 462 may select an operating frequency for an exit gate (e.g., exit gate 310b) that is different than the operating frequency of a neighbor exit gate (e.g., exit gate 310a and/or exit gate 310c). When implemented at the evaluation computer 126, the frequency selection component 462 may select the operating frequency for each exit gate. When implemented at an RFID reader, the frequency selection component 462 may detect operating frequencies in use by adjacent gates (e.g., based on RSSI) or via network signaling from the adjacent gates or RFID readers, and select a different operating frequency. In some implementations, the closest exit gate operating on the same operating frequency as any of the plurality of exit gates is separated by at least two exit gates operating on different operating frequencies. For example, the exit gate 310a may be separated from the exit gate 310d by the exit gate 310b and the exit gate 310c. In some implementations, where the exit gates are arranged linearly, the frequency selection component 462 may assign each frequency gate along a line an operating frequency that cycles through the available operating frequencies (e.g., 3).

The RFID reader configuration application 460 may include a synchronization component 464 that synchronizes the RFID reader with the one or more RFID readers located at the same exit gate to talk at a different time, with a different coverage area, or with a different polarization than the one or more RFID readers located at the same exit gate. In some implementations, the synchronization component 464 may configure the RFID reader with a non-overlapping schedule for talking. For instance, in an exit gate with three RFID readers, each reader may have a one-third duty cycle. In another implementation, the synchronization component 464 may configure an overlapping schedule where two or more of the RFID readers talk at the same time using non-overlapping beams and/or different polarizations. In some cases, for each time period, the overlapping schedule may include two RFID readers talking with non-overlapping beams and opposite or orthogonal polarizations. The synchronization component 464 may also select the transmission power of the beams. For example, the synchronization component 464 may select a greater transmission power for beams pointed toward an area where fewer tags are expected (e.g., outside of the retail location) than an area where more tags are expected (e.g., toward a display rack). Further, in some implementations, the schedule may include different sessions including single detection sessions and dual detection sessions. The synchronization component 464 may configure a greater number of the dual detection sessions (e.g., two-thirds) than single detection sessions (e.g., one-third).

The RFID reader configuration application 460 may include a tag detection component 466. The tag detection component 466 may detect one or more tags within the coverage area. For example, the tag detection component 466 may process RFID signals received from tags within the coverage area of an RFID reader. The tag detection component 466 may determine exit system measurements for the tag detection event. For example, the exit system measurements may include one or more properties read from a tag. The exit system measurements may include any information stored on the EPC tag 124 as well as additional information about reading the EPC tag 124. For example, the EPC tag data set may include: a timestamp, a location, a signal transmission power, a received signal strength indication (RSSI), a phase angle of the tag, and an identifier of the sensor 142. The additional information may be included in the exit system measurements. For example, the exit system measurements may include a number of tags read over time; the RSSI of the tag; a change in RSSI over time, frequency, or beam; a phase angle of the tag; a speed of the tag; a number of people between sensors of the exit system 140; a number of people in an exit area; a location history of a person associated with the tag; a duration of the tag being read; and a stock keeping unit (SKU) of the tag being read. The tag detection component 466 may provide a tag event data set to a higher layer classifier that determines a tag status.

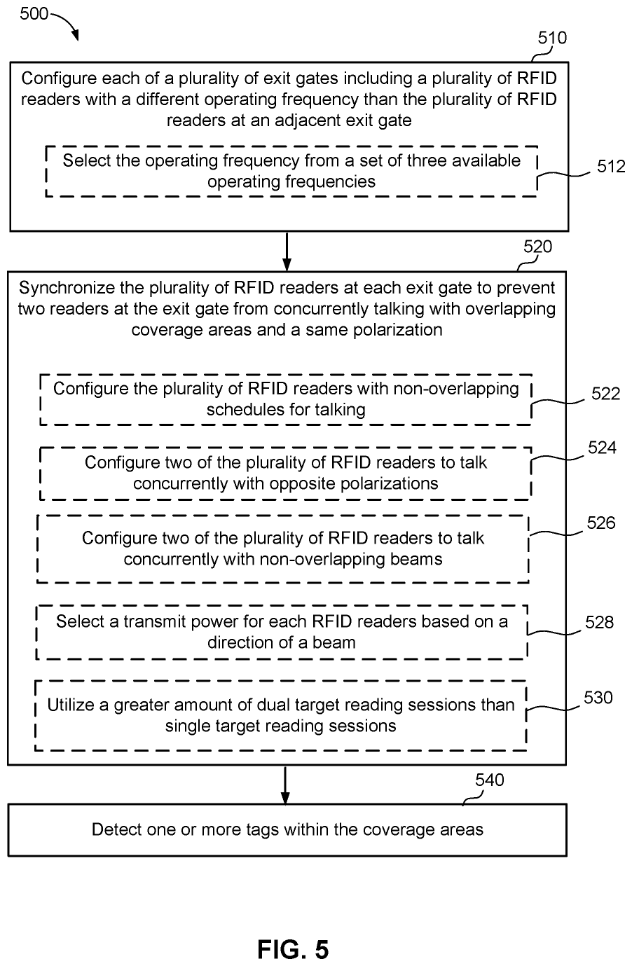

Turning to FIG. 5, an example method 500 configures one or more RFID readers 320 for reading RFID tags. For example, method 500 may be performed by the RFID reader configuration application 460 on the computer device 440, which may be an example of an RFID reader 320 or a device such as evaluation computer 126 that is coupled with multiple RFID readers 320 and provides remote configuration. Optional blocks are shown with dashed lines.

At block 510, the method 500 may include configuring each of a plurality of exit gates including a plurality of RFID readers with a different operating frequency than the plurality of RFID readers at an adjacent exit gate. In an aspect, for example, the frequency selection component 462 may configure each of a plurality of exit gates 310 (e.g., exit gate 310a) including a plurality of RFID readers 320 with a different operating frequency than the plurality of RFID readers at an adjacent exit gate (e.g., exit gate 310a or 310c. In some implementations, where each RFID reader 320 includes an RFID reader configuration application 460, the RFID reader 320 may communicate with the other RFID readers 320 (e.g., via network interface 448) to select the operating frequency. For example, at sub-block 512, the frequency selection component 462 may select the operating frequency from a set of three available operating frequencies.

At block 520, the method 500 may include synchronizing the plurality of RFID readers at each exit gate to prevent two readers at the exit gate from concurrently talking with overlapping coverage areas and a same polarization. In an aspect, for example, the synchronization component 464 may synchronize the plurality of RFID readers at each exit gate to prevent two readers at the exit gate from concurrently talking with overlapping coverage areas and a same polarization. For instance, the synchronization component 464 may determine a schedule for one or more RFID readers 320.

At sub-block 522, the block 520 may include configuring the plurality of RFID readers with non-overlapping schedules for talking. For example, the synchronization component 464 may assign periodic intervals to each RFID reader such that the schedules of the RFID readers are interleaved.

At sub-block 524, the block 520 may include configuring two of the plurality of RFID readers to talk concurrently with opposite polarizations. For example, the synchronization component 464 may select the opposite polarizations for two of the plurality of the RFID readers.

At sub-block 526, the block 520 may include configuring two of the plurality of RFID readers to talk concurrently with non-overlapping beams. For example, the synchronization component 464 may select a beam for each of the two RFID readers that points in a different direction. For instance, the beams may be separated by a minimum angle (e.g., at least 14 degrees of separation between the centers of the beams).

At sub-block 528, the block 520 may include selecting a transmit power for each RFID readers based on a direction of a beam. For example, the synchronization component 464 may select lower transmit powers for beams directed toward known locations of stationary tags (e.g., display shelves or racks). In contrast, beams directed toward the exit may transmit with greater power.

At sub-block 530, the block 520 may include utilizing a greater amount of dual target reading sessions than single target reading sessions. For example, the synchronization component 464 may assign approximately two dual target reading sessions for every single target reading session.

At block 540, the method 500 may include detecting one or more tags within the coverage areas. For example, the tag detection component 466 may detect one or more tags within the coverage areas. That is, the tag detection component 466 may receive one or more signals transmitted by tags within a coverage area. Due to the selection of the operating frequency and the synchronization between RFID readers 320, the signals transmitted by the tags may have sufficient co-channel rejection that the tag detection component 466 is able to measure the signals and detect the tags.

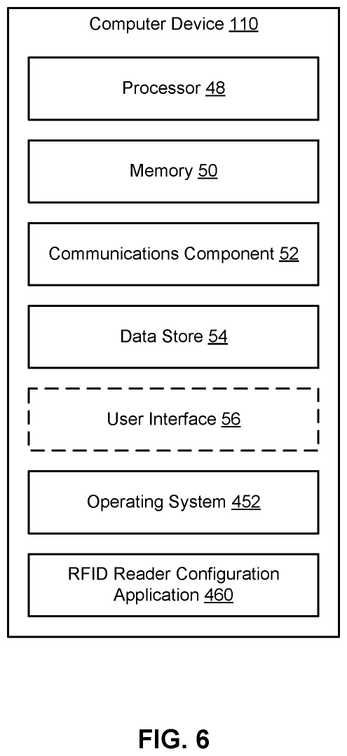

Referring now to FIG. 6, illustrated is an example computer device 440 in accordance with an implementation, including additional component details as compared to FIG. 4. In one example, computer device 440 may include processor 48 for carrying out processing functions associated with one or more of components and functions described herein. Processor 48 can include a single or multiple set of processors or multi-core processors. Moreover, processor 48 can be implemented as an integrated processing system and/or a distributed processing system. In an implementation, for example, processor 48 may include CPU 442.

In an example, computer device 440 may include memory 50 for storing instructions executable by the processor 48 for carrying out the functions described herein. In an implementation, for example, memory 50 may include memory 444. The memory 50 may include instructions for executing the RFID reader configuration application 460.

Further, computer device 440 may include a communications component 52 that provides for establishing and maintaining communications with one or more parties utilizing hardware, software, and services as described herein. Communications component 52 may carry communications between components on computer device 440, as well as between computer device 440 and external devices, such as devices located across a communications network and/or devices serially or locally connected to computer device 440. For example, communications component 52 may include one or more buses, and may further include transmit chain components and receive chain components associated with a transmitter and receiver, respectively, operable for interfacing with external devices.

Additionally, computer device 440 may include a data store 54, which can be any suitable combination of hardware and/or software, that provides for mass storage of information, databases, and programs employed in connection with implementations described herein. For example, data store 54 may be a data repository for operating system 452 and/or applications 454. The data store may include memory 444 and/or storage device 446.

Computer device 440 may also include a user interface component 56 operable to receive inputs from a user of computer device 440 and further operable to generate outputs for presentation to the user. User interface component 56 may include one or more input devices, including but not limited to a keyboard, a number pad, a mouse, a touch-sensitive display, a digitizer, a navigation key, a function key, a microphone, a voice recognition component, any other mechanism capable of receiving an input from a user, or any combination thereof. Further, user interface component 56 may include one or more output devices, including but not limited to a display, a speaker, a haptic feedback mechanism, a printer, any other mechanism capable of presenting an output to a user, or any combination thereof.

In an implementation, user interface component 56 may transmit and/or receive messages corresponding to the operation of operating system 452 and/or applications 454. In addition, processor 48 may execute operating system 452 and/or applications 454, and memory 50 or data store 54 may store them.

As used in this application, the terms “component.” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computer device and the computer device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Additional example implementations are described in the following numbered clauses:

1. A radio frequency identification (RFID) reader comprising:
an antenna component configurable to transmit on an operating frequency using one of two polarizations and one of at least three beams; and
a controller configured to:
   select the operating frequency that is the same as an operating frequency of one or more RFID readers located at a same exit gate and different from an operating frequency of an RFID reader located at an adjacent exit gate;
   synchronize with the one or more RFID readers located at the same exit gate to talk at a different time, with a different coverage area, or with a different polarization than the one or more RFID readers located at the same exit gate; and
   detect one or more tags within a selected coverage area.
      2. The RFID reader of clause 1, wherein to synchronize with the one or more RFID readers located at the same exit gate, the controller is configured to receive a schedule for talking that does not overlap with any schedule of the one or more RFID readers located at the same exit gate.
      3. The method of clause 1, wherein to synchronize with the one or more RFID readers located at the same exit gate, the controller is configured to talk concurrently with another RFID readers located at the same exit gate with an opposite polarization.
      4. The RFID reader of clause 1 or 3, wherein to synchronize with the one or more RFID readers located at the same exit gate, the controller is configured to talk concurrently with another RFID readers located at the same exit gate with non-overlapping beams.
      5. The RFID reader of any of clauses 1-4, wherein the different operating frequency is selected from a set of three available operating frequencies.
      6. The RFID reader of clause 5, wherein the adjacent exit gate is configured with a second available operating frequency and a second adjacent exit gate on an opposite side of the exit gate is configured with a third available operating frequency.
      7. The RFID reader of clause 5 or 6, wherein the RFID reader is separated from another exit gate operating on the same frequency by at least two exit gates operating on different operating frequencies.
      8. The RFID reader of any of clauses 5-7, wherein the plurality of exit gates are arranged linearly and the operating frequency for each exit gate along a line cycles through the three available operating frequencies.
      9. The RFID reader of any of clauses 1-8, wherein to synchronize with the one or more RFID readers located at the same exit gate, the controller is configured to select a transmit power for the RFID reader based on a direction of a beam.
      10. The RFID reader of any of clauses 1-9, wherein to synchronize with the one or more RFID readers located at the same exit gate, the controller is configured to utilize a greater amount of dual target reading sessions than single target reading sessions.
      11. A system comprising:
a plurality of radio frequency identification (RFID) readers located at each of a plurality of exit gates, each exit gate configured with a different operating frequency than an adjacent exit gate; and
a controller configured to:
   synchronize the plurality of RFID readers at one of the exit gates to prevent two readers at the exit gate from concurrently talking with overlapping coverage areas and a same polarization; and
   detect one or more tags within the coverage areas.
      12. The system of clause 11, wherein to synchronize the plurality of RFID readers at the exit gate, the controller is configured to configure the plurality of RFID readers with non-overlapping schedules for talking.
      13. The system of clause 11, wherein to synchronize the plurality of RFID readers at the exit gate, the controller is configured to configure two of the plurality of RFID readers to talk concurrently with opposite polarizations.
      14. The system of clause 11 or 13, wherein to synchronize the plurality of RFID readers at the exit gate, the controller is configured to configure two of the plurality of RFID readers to talk concurrently with non-overlapping beams.
      15. The system of any of clauses 11-14, wherein the different operating frequency is selected from a set of three available operating frequencies.
      16. The system of clause 15, wherein the adjacent exit gate is configured with a second available operating frequency and a second adjacent exit gate on an opposite side of the exit gate is configured with a third available operating frequency.
      17. The system of clause 15 or 16, wherein a closest exit gate operating on a same operating frequency as any of the plurality of exit gates is separated by at least two exit gates operating on different operating frequencies.
      18. The system of any of clauses 15-17, wherein the plurality of exit gates are arranged linearly and the operating frequency for each exit gate along a line cycles through the three available operating frequencies.
      19. The system of any of clauses 11-18, wherein to synchronize the plurality of RFID readers at the exit gate, the controller is configured to select a transmit power for each RFID reader based on a direction of a beam.
      20. The system of clauses 11-19, wherein to synchronize the plurality of RFID readers at the exit gate, the controller is configured to configure the plurality of RFID readers to utilize a greater amount of dual target reading sessions than single target reading sessions.
      21. A method comprising:
configuring each of a plurality of exit gates including a plurality of radio frequency identification (RFID) readers with a different operating frequency than the plurality of RFID readers at an adjacent exit gate;
synchronizing the plurality of RFID readers at each exit gate to prevent two readers at the exit gate from concurrently talking with overlapping coverage areas and a same polarization; and
detecting one or more tags within the coverage areas.
   22. The method of clause 21, wherein synchronizing the plurality of RFID readers at an exit gate comprises configuring the plurality of RFID readers with non-overlapping schedules for talking.
   23. The method of clause 21, wherein synchronizing the plurality of RFID readers at an exit gate comprises configuring two of the plurality of RFID readers to talk concurrently with opposite polarizations.
   24. The method of clause 21 or 23, wherein synchronizing the plurality of RFID readers at an exit gate comprises configuring two of the plurality of RFID readers to talk concurrently with non-overlapping beams.
   25. The method of any of clauses 21-24, wherein the different operating frequency is selected from a set of three available operating frequencies.
   26. The method of clause 25, wherein the adjacent exit gate is configured with a second available operating frequency and a second adjacent exit gate on an opposite side of the exit gate is configured with a third available operating frequency.
   27. The method of clause 25 or 26, wherein a closest exit gate operating on a same operating frequency as any of the plurality of exit gates is separated by at least two exit gates operating on different operating frequencies.
   28. The method of any of clauses 25-27, wherein the plurality of exit gates are arranged linearly and the operating frequency for each exit gate along a line cycles through the three available operating frequencies.
   29. The method of any of clauses 21-28, wherein synchronizing the plurality of RFID readers at each exit gate comprises selecting a transmit power for each RFID reader based on a direction of a beam.
   30. The method of any of clauses 21-29, wherein synchronizing the plurality of RFID readers at each exit gate comprises utilizing a greater amount of dual target reading sessions than single target reading sessions.

Various implementations or features may have been presented in terms of systems that may include a number of devices, components, modules, and the like. A person skilled in the art should understand and appreciate that the various systems may include additional devices, components, modules, etc. and/or may not include all of the devices, components, modules etc. discussed in connection with the figures. A combination of these approaches may also be used.

The various illustrative logics, logical blocks, and actions of methods described in connection with the embodiments disclosed herein may be implemented or performed with a specially-programmed one of a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computer devices, e.g., a combination of a DSP and a microprocessor, a plurality of microprocessors, one or more microprocessors in conjunction with a DSP core, or any other such configuration. Additionally, at least one processor may comprise one or more components operable to perform one or more of the steps and/or actions described above.

Further, the steps and/or actions of a method or procedure described in connection with the implementations disclosed herein may be embodied directly in hardware, in a software module executed by a processor, or in a combination of the two. A software module may reside in RAM memory, flash memory, ROM memory. EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some implementations, the processor and the storage medium may reside in an ASIC. Additionally, the ASIC may reside in a user terminal. In the alternative, the processor and the storage medium may reside as discrete components in a user terminal. Additionally, in some implementations, the steps and/or actions of a method or procedure may reside as one or any combination or set of codes and/or instructions on a machine readable medium and/or computer readable medium, which may be incorporated into a computer program product.

In one or more implementations, the functions described may be implemented in hardware, software, firmware, or any combination thereof. If implemented in software, the functions may be stored or transmitted as one or more instructions or code on a computer-readable medium. Computer-readable media includes computer storage media. Non-transitory computer-readable media excludes transitory signals. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray disc where disks usually reproduce data magnetically, while discs usually reproduce data optically with lasers. Combinations of the above should also be included within the scope of computer-readable media.

While implementations of the present disclosure have been described in connection with examples thereof, it will be understood by those skilled in the art that variations and modifications of the implementations described above may be made without departing from the scope hereof. Other implementations will be apparent to those skilled in the art from a consideration of the specification or from a practice in accordance with examples disclosed herein.

What is claimed is:

1. A radio frequency identification (RFID) reader comprising:
an antenna component configurable to transmit on an operating frequency using one of two polarizations; and
a controller configured to:
select the operating frequency that is the same as an operating frequency of one or more RFID readers located at a same exit gate and different from an operating frequency of an RFID reader located at an adjacent exit gate;
synchronize with the one or more RFID readers located at the same exit gate to talk at a different time, with a different coverage area, or with a different polarization than the one or more RFID readers located at the same exit gate; and
detect one or more tags within a selected coverage area.

2. The RFID reader of claim 1, wherein to synchronize with the one or more RFID readers located at the same exit gate, the controller is configured to receive a schedule for talking that does not overlap with any schedule of the one or more RFID readers located at the same exit gate.

3. The RFID reader of claim 1, wherein to synchronize with the one or more RFID readers located at the same exit gate, the controller is configured to talk concurrently with another RFID readers located at the same exit gate with an opposite polarization.

4. The RFID reader of claim 1, wherein the antenna component is configurable to transmit using one of at least three beams, wherein to synchronize with the one or more RFID readers located at the same exit gate, the controller is configured to talk concurrently with another RFID reader located at the same exit gate with non-overlapping beams.

5. The RFID reader of claim 1, wherein the different operating frequency is selected from a set of three available operating frequencies.

6. The RFID reader of claim 5, wherein the adjacent exit gate is configured with a second available operating frequency and a second adjacent exit gate on an opposite side of the exit gate is configured with a third available operating frequency.

7. The RFID reader of claim 5, wherein the RFID reader is separated from another exit gate operating on the same frequency by at least two exit gates operating on different operating frequencies.

8. The RFID reader of claim 5, wherein the exit gate including the RFID reader is among a plurality of exit gates that are arranged linearly and the operating frequency for each exit gate along a line cycles through the three available operating frequencies.

9. The RFID reader of claim 1, wherein to synchronize with the one or more RFID readers located at the same exit gate, the controller is configured to select a transmit power for each RFID reader based on a direction of a beam.

10. The RFID reader of claim 1, wherein to synchronize with the one or more RFID readers located at the same exit gate, the controller is configured to utilize a greater amount of dual target reading sessions than single target reading sessions.

11. A system comprising:
a plurality of radio frequency identification (RFID) readers located at each of a plurality of exit gates, each exit gate configured with a different operating frequency than an adjacent exit gate; and
a controller configured to:
synchronize the plurality of RFID readers at one of the exit gates to prevent two readers at the exit gate from concurrently talking with overlapping coverage areas and a same polarization; and
detect one or more tags within the coverage areas.

12. The system of claim 11, wherein to synchronize the plurality of RFID readers at the exit gate, the controller is configured to configure the plurality of RFID readers with non-overlapping schedules for talking.

13. The system of claim 11, wherein to synchronize the plurality of RFID readers at the exit gate, the controller is configured to configure two of the plurality of RFID readers to talk concurrently with opposite polarizations.

14. The system of claim 11, wherein to synchronize the plurality of RFID readers at the exit gate, the controller is configured to configure two of the plurality of RFID readers to talk concurrently with non-overlapping beams.

15. The system of claim 11, wherein the different operating frequency is selected from a set of three available operating frequencies.

16. The system of claim 15, wherein the adjacent exit gate is configured with a second available operating frequency and a second adjacent exit gate on an opposite side of the exit gate is configured with a third available operating frequency.

17. The system of claim 15, wherein a closest exit gate operating on a same operating frequency as any of the plurality of exit gates is separated by at least two exit gates operating on different operating frequencies.

18. The system of claim 15, wherein the plurality of exit gates are arranged linearly and the operating frequency for each exit gate along a line cycles through the three available operating frequencies.

19. The system of claim 11, wherein to synchronize the plurality of RFID readers at the exit gate, the controller is configured to select a transmit power for each RFID reader based on a direction of a beam.

20. The system of claim 11, wherein to synchronize the plurality of RFID readers at the exit gate, the controller is configured to configure the plurality of RFID readers to utilize a greater amount of dual target reading sessions than single target reading sessions.

21. A method comprising:
configuring each of a plurality of exit gates including a plurality of radio frequency identification (RFID) readers with a different operating frequency than the plurality of RFID readers at an adjacent exit gate;
synchronizing the plurality of RFID readers at each exit gate to prevent two readers at the exit gate from concurrently talking with overlapping coverage areas and a same polarization; and
detecting one or more tags within the coverage areas.

22. The method of claim 21, wherein synchronizing the plurality of RFID readers at an exit gate comprises configuring the plurality of RFID readers with non-overlapping schedules for talking.

23. The method of claim 21, wherein synchronizing the plurality of RFID readers at an exit gate comprises configuring two of the plurality of RFID readers to talk concurrently with opposite polarizations.

24. The method of claim 21, wherein synchronizing the plurality of RFID readers at an exit gate comprises configuring two of the plurality of RFID readers to talk concurrently with non-overlapping beams.

25. The method of claim 21, wherein the different operating frequency is selected from a set of three available operating frequencies.

26. The method of claim 25, wherein the adjacent exit gate is configured with a second available operating frequency and a second adjacent exit gate on an opposite side of the exit gate is configured with a third available operating frequency.

27. The method of claim 25, wherein a closest exit gate operating on a same operating frequency as any of the plurality of exit gates is separated by at least two exit gates operating on different operating frequencies.

28. The method of claim 25, wherein the plurality of exit gates are arranged linearly and the operating frequency for each exit gate along a line cycles through the three available operating frequencies.

29. The method of claim 21, wherein synchronizing the plurality of RFID readers at each exit gate comprises selecting a transmit power for each RFID reader based on a direction of a beam.

30. The method of claim 21, wherein synchronizing the plurality of RFID readers at each exit gate comprises utilizing a greater amount of dual target reading sessions than single target reading sessions.
